(19) United States
(12) Patent Application Publication
(10) Pub. No.: US 2003/0087011 A1
(43) Pub. Date: May 8, 2003

(54) Frozen confectionery accessory

(76) Inventor: Jana Gaye Perkins, Houston, TX (US)

Correspondence Address: JANA PERKINS, 11203 PATRIDGE, HOUSTON, TX, 77070, US

(21) Appl. No.: 09/986,285

(22) Filed: Nov. 8, 2001

(51) Int. Cl. A23G 1/00

(52) U.S. Cl. 426/134

(57) ABSTRACT

An accessory for preventing messes and stains resulting from the melting of a frozen confectionery mounted on a stick. The accessory includes a cup structure having a cavity provided therein in a bottom surface through which a resiliently, sealably inner slot is provided for receiving there through the stick of the frozen confectionery. The upper perimeter rim of the cup has inwardly projecting lip so that the frozen confectionery cup combination can be tilted to the required angle for consumption of the confectionery without any melted materials rolling out of the cup onto the clothing of the consumer.

### TECHNICAL FIELD

The present invention relates to accessories for frozen accessories such as ice pops, fudge pops and the like and more particularly to a frozen confectionery accessory for use with a frozen confectionery on a stick that includes a flexible plastic or rubber cup having a center slot provided through a bottom of a drip capturing cavity defined therein that is adapted to resiliently, sealably receive there through the stick handle of a frozen confectionery on a stick in a manner such that any liquid generated by melting of the frozen confectionery is maintained within the cup; a rim of the cup being provided with an inwardly projecting lid portion such that when a person orients a frozen confectionery at an angle for eating, licking, etc. any melted liquids are maintained within the drip capturing cavity.

### BACKGROUND OF INVENTION

Children and adults alike enjoy eating frozen confectioneries that are typically mounted onto a stick. The problem with these frozen confectioneries is as they are eaten they typically begin to melt and drip onto the clothing and face of the user causing stains and a mess which must be cleaned up. It would be desirable, therefore, to have a frozen confectionery accessory that included a cup like capturing structure having a bottom surface with a resilient sealing slot for receiving therethrough the tip end of a stick of a frozen confectionery. The cup would desirably include an inwardly projecting upper perimeter lip which would maintain any liquefied frozen confectionery within the cavity when the combination of frozen confectionery and frozen confectionery accessory was tilted at an angle for consumption by the consumer.

### SUMMARY OF INVENTION

It is thus an object of the invention to provide a frozen confectionery accessory that includes a flexible plastic or rubber cup having a center slot provided through a bottom of a drip capturing cavity defined therein that is adapted to resiliently, sealably receive there through the stick handle of a frozen confectionery on a stick in a manner such that any liquid generated by melting of the frozen confectionery is maintained within the cup; a rim of the cup being provided with an inwardly projecting lid portion such that when a person orients a frozen confectionery at an angle for eating, licking, etc. any melted liquids are maintained within the drip capturing cavity.

Accordingly, a frozen confectionery accessory is provided. The frozen confectionery accessory includes a flexible plastic or rubber cup having a center slot provided through a bottom of a drip capturing cavity defined therein that is adapted to resiliently, sealably receive there through the stick handle of a frozen confectionery on a stick in a manner such that any liquid generated by melting of the frozen confectionery is maintained within the cup; a rim of the cup being provided with an inwardly projecting lid portion such that when a person orients a frozen confectionery at an angle for eating, licking, etc. any melted liquids are maintained within the drip capturing cavity.

### BRIEF DESCRIPTION OF DRAWINGS

For a further understanding of the nature and objects of the present invention, reference should be had to the following detailed description, taken in conjunction with the accompanying drawings, in which like elements are given the same or analogous reference numbers and wherein:

FIG. 1 shows an exemplary embodiment of a side cut away view of the frozen confectionary accessory of the present invention.

FIG. 2 is a top plan view of the frozen confectionary accessory of the present invention.

FIG. 3 is a perspective view of the frozen confectionary accessory of the present invention with a representative frozen confectionary on a stick secured thereto.

FIG. 4 is a perspective view of the frozen confectionary accessory in isolation.

FIG. 5 is a top plan view of the frozen confectionary accessory.

FIG. 6 is a cross sectional side view of the frozen confectionary accessory.

### EXEMPLARY EMBODIMENTS

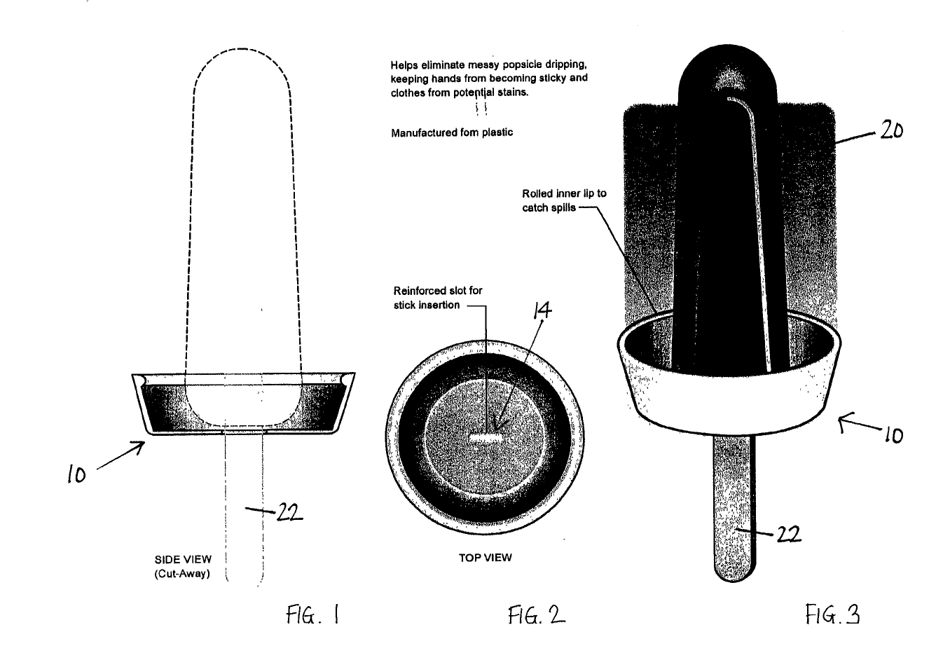

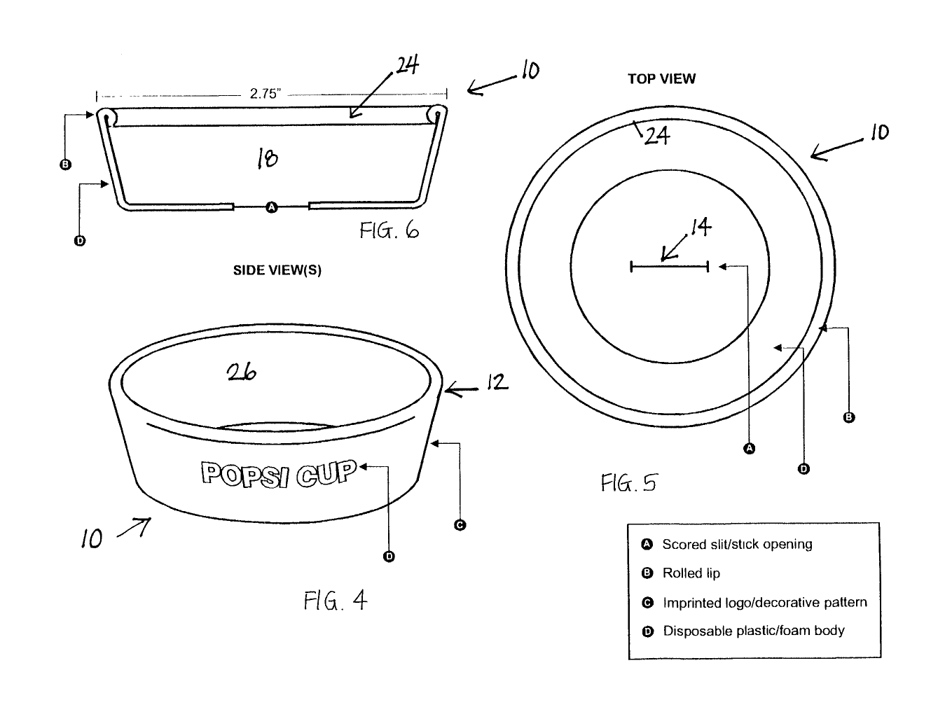

FIGS. 1 through 6 show various aspects of an exemplary embodiment of the frozen confectionery accessory of the present invention generally designated 10. Frozen confectionery accessory 10 includes a flexible plastic or rubber cup generally designated 12 having a center slot generally designated 14 formed through a bottom surface 16 thereof. Cup 12 has a lip capturing cavity 18 defined therein for capturing the melted run off from a frozen confectionery such as a frozen pop or frozen fudge pop 20 shown in FIG. 3. Frozen fudge pop 20 is provided with a wooden stick 22.

Cup 12 is provided with a rim portion 24 that extends into toward the center of the top opening 26 of cup 12 so as to prevent the melted run off from running out of the drip capturing cavity 18 when the user tilts the combination frozen pop 20 and cup 12 during use. Slot 14 is sized and resiliently constructed such that it forms a seal against leakage when stick 22 is inserted-therethrough.

It can be seen from the preceding description that a frozen confectionery accessory has been provided.

It is noted that the embodiment of the frozen confectionery accessory described herein in detail for exemplary purposes is of course subject to many different variations in structure, design, application and methodology. Because many varying and different embodiments may be made within the scope of the inventive concept(s) herein taught, and because many modifications may be made in the embodiment herein detailed in accordance with the descriptive requirements of the law, it is to be understood that the details herein are to be interpreted as illustrative and not in a limiting sense.

1. What I claim as my invention is a frozen confectionery accessory (a cup device that can be made as disposable or not out of plastic or rubber) that is used in conjuction with frozen confections such as popsicles, fudge bars, ice cream bars on sticks and the like, that will catch and contain any liquid (drips) generated by the melting confections just by inserting the frozen confection through a center slot provided in the bottom of the cup device then with the top rim of the cup having a rolled inner lip to catch any maintained liquid (drips) when the frozen confection is turned at an angle for eating, licking, etc.
